(19) United States
(12) Patent Application Publication
(10) Pub. No.: US 2013/0305922 A1
(43) Pub. Date: Nov. 21, 2013

(54) GAS DEHUMIDIFICATION BY MICROPOROUS COORDINATION POLYMERS

(71) Applicant: The Regents of the University of Michigan, Ann Arbor, MI (US)

(72) Inventors: Adam J. MATZGER, Ann Arbor, MI (US); Antek G. Wong-Foy, Ann Arbor, MI (US); Ping Guo, Ann Arbor, MI (US)

(73) Assignee: The Regents of the University of Michigan, Ann Arbor, MI (US)

(21) Appl. No.: 13/895,664

(22) Filed: May 16, 2013

Related U.S. Application Data
(60) Provisional application No. 61/649,033, filed on May 18, 2012.

(51) Int. Cl. B01D 53/04

(52) U.S. Cl. CPC B01D 53/0407
USPC 95/123; 95/122; 95/126

(57) ABSTRACT

A gas-dehumidification method can include passing a humid gas stream through a water-sorbing sorbent comprising a microporous coordination polymer or derivative thereof, wherein the sorbent sorbs water from the passing humid gas stream to produce a water-sorbed sorbent and a dehumidified gas stream. The method can further include passing a drying gas through the water-sorbed sorbent under conditions sufficient to desorb the water and to regenerate the water-sorbing sorbent.

### STATEMENT OF GOVERNMENT INTEREST

This invention was made with government support under grant number DE-SC0004888 awarded by the U.S. Department of Energy. The government has certain rights in the invention.

### FIELD OF THE DISCLOSURE

The present disclosure is directed to methods of dehumidifying gas, and more particularly, to methods of dehumidifying gas using macroporous coordination polymers.

### BACKGROUND

It is often desirable to remove water from air and other gases to avoid the negative effects that can be caused by liquid formation, such as corrosion and catalyst contamination. Activated alumina has enjoyed widespread use as a desiccant due to its low cost, chemical and physical resistance, and regenerability. However, large amounts of energy are required to produce the high temperatures and/or reduced pressures that are necessary for regeneration of the alumina. Alumina is not particularly well-suited for drying air and other gases with low relative humidity, and alumina has a limited capacity for water.

Zeolites have been used as an alternative to activated alumina in dehumidification applications. Zeolites have been found to be of particular use in drying gases with low relative humidity. However, a drawback to using a zeolite as a desiccant is its low water capacity and difficulty with regeneration.

Microporous coordination polymers (MCPs) are comprised of metal ions or metal clusters connect by organic ligands, resulting in a porous structure. MCPs have shown promise for applications such as gas storage, gas separations, and catalysis due to their high surface area and high thermal stability. However, many MCPs are considered in the art as unstable in atmospheric conditions and have been shown to decompose when left exposed to the atmosphere.

U.S. Patent Publication No. 2009/0130411 to Chang discloses a hybrid inorganic-organic material that has a water adsorption capacity of about 100 wt. % at about 75% relative humidity under static conditions and about 90% of the adsorbed water is desorbed at temperatures less than 70° C. However, the hybrid inorganic-organic material disclosed in Chang does not effectively adsorb water from air having a low relative humidity. Chang further teaches that there is substantially no change in the amount of water desorbed from the adsorbent at temperatures above 70° C., and at temperatures above 300° C. the adsorbent decomposes.

### SUMMARY

Disclosed herein is a gas-dehumidification method. In one embodiment, the method includes passing a humid gas stream through a water-sorbing sorbent including a microporous coordination polymer or derivative thereof, wherein the sorbent sorbs water from the passing humid gas stream to produce a water-sorbed sorbent and a dehumidified gas stream. The method also includes passing a drying gas through the water-sorbed sorbent under conditions sufficient to desorb the water and to regenerate the water-sorbing sorbent.

In another embodiment, the method includes passing a humid gas stream through a water-sorbing sorbent including a microporous coordination polymer or derivative thereof, wherein the sorbent sorbs water from the passing humid gas stream to produce a water-sorbed sorbent and a dehumidified gas stream. This method also includes heating the water-sorbed sorbent to a temperature in a range of about 70° C. to about 250° C. to desorb the water and to regenerate the water-sorbing sorbent.

In either of the embodiments disclosed above the humid gas stream can be a humid air stream.

Optionally, the microporous coordination polymer of the sorbents described herein can contain metal centers that are coordinatively unsaturated.

Optionally, the microporous coordination polymer of the sorbents described herein can be modified with a component selected from the group consisting of amines, alcohols, ethers, ketones, esters, carboxylic acids, amides, phosphonates, phosphates, sulfoxides, sulfones, sulfonamide, thiols, nitriles, and combinations thereof.

For the sorbents and methods described herein, optional features, including but not limited to components, compositional ranges thereof, substituents, conditions, and steps, are contemplated to be selected from the various aspects, embodiments, and examples provided herein.

Further aspects and advantages will be apparent to those of ordinary skill in the art from a review of the following detailed description. While the compositions and methods are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

FIG. 1 is graph illustrating the water/air breakthrough curves for (a) commercially available, conventional activated alumina, (b) Co/DOBDC, (c) HKUST-1, (d) MIL-100, and (e) MIL-101. The curves were generated under the following conditions: a pressure of 14.7 psi, NIST STP flow rate of 30 mL/min, 75% relative humidity, and at a temperature of 25° C. Curves (b)-(e) represent the results using MCPs in accordance with embodiments of the methods of the disclosure;

FIG. 2 is a graph illustrating the water/air breakthrough curves of (a) initially activated and (b) regenerated HKUST-1 generated using methods of dehumdifying in accordance with embodiments of the disclosure;

FIG. 3 is a graph illustrating the water/air breakthrough curves of (a) initially activated and (b) regenerated Co/DOBDC, generated using methods of dehumdifying in accordance with embodiments of the disclosure; and

FIG. 4 is a graph illustrating the water/air breakthrough curves of (a) initially activated and (b) regenerated MIL-101, generated using methods of dehumdifying in accordance with embodiments of the disclosure.

### DETAILED DESCRIPTION

It has been discovered that microporous coordination polymers can be used as sorbents for the adsorption/absorption of water (referred to herein as water-sorbents)from a humid gas stream, thereby dehumidifying the gas stream. Accordingly, disclosed herein are embodiments of gas-dehumidification methods using microporous coordination polymers as water-sorbents. Generally, the gas-dehumidification method can include passing a humid gas stream through a water-sorbing sorbent. The sorbent includes a microporous coordination polymer or derivative thereof. The sorbent sorbs water from the passing humid gas stream to produce a water-sorbed sorbent and a dehumidified gas stream. As used herein, “sorbed” refers to both adsorbing and absorbing.

The method can further include regenerating the water-sorbed sorbent to allow, for example, the sorbent to be subsequently (and repeatedly) used for dehumidifying a further humid gas stream. In some embodiments, the water-sorbed sorbent can be regenerated by passing a drying gas through the water-sorbed sorbent under conditions sufficient to desorb the water and to regenerate the water-sorbing sorbent. In other embodiments, the water-sorbed sorbent can be heated during the regeneration process in addition to the passage of the drying gas across the sorbent. Alternatively, in some embodiments, the water-sorbed sorbent can be regenerated by heating the water-sorbed sorbent to a temperature in a range of about 70° C. to about 250° C. to desorb the water and to regenerate the water-sorbing sorbent. In such embodiments, a drying gas can also be passed through the water-sorbed sorbent during heating. Once the water-sorbing sorbent is regenerated, it may be used to further sorb water from a humid gas stream. While the present disclosure provides humid air examples, the microporous coordination polymers and sorbents described herein can be used for the dehumidification of other gases, including, but not limited oxygen, argon, hydrogen, carbon monoxide, carbon dioxide, light hydrocarbons, and nitrogen.

The gas-dehumidification methods of the disclosure advantageously provide a method in which the sorbents comprising MCPs or derivatives thereof can be efficiently and effectively regenerated for subsequent dehumidification without the significant energy costs required for regeneration of conventional sorbents. The sorbents used in the methods of the disclosure can advantageously be used in repeated water-sorption/water-desorption cycles with little to no loss of sorbing-efficiency. The methods of the disclosure advantageously recognize the effectiveness of sorbents containing MCPs in dehumidifying gas and providing tailorable sorbents. For example, the sorbents can be modified such that the water-sorbing capacity and water affinity of the sorbent suit a particular application, such as low or high humidity conditions. Further, the methods of the disclosure advantageously recognize that effective regeneration of the water-sorbing sorbent from the water-sorbed sorbent can be achieved if the water is sorbed under dynamic conditions, as opposed to static conditions, and that the sorbent is more stable towards water when used in a water-sorption/water-desorption cycle such that the water-sorbed sorbent does not remain saturated for an extended period of time.

A MCP sorbent of the disclosure is useful for gas dehumidification applications. In one embodiment, a gas-dehumidification method includes passing a humid gas stream through a water-sorbing sorbent comprising a microporous coordination polymer, wherein the sorbent sorbs water from the passing humid gas stream to produce a water-sorbed sorbent and a dehumidified gas stream. This method also includes passing a drying gas through the water-sorbed sorbent under conditions sufficient to desorb the water and to regenerate the water-sorbing sorbent. Optionally, the water-sorbed sorbent is heated to a temperature in the range of about 70° C. to about 300° C., or about 70° C. to about 250° C., or about 100° C. to about 300° C., or about 100° C. to about 250° C., or about 100° C. to about 200° C. Other suitable temperatures include, for example, about 70, 80, 90, 100, 110, 120, 130, 140, 150, 160, 170, 180, 190, 200, 210, 220, 230, 240, 250, 260, 270, 280, 290, or 300° C.

In another embodiment, a gas-dehumidification method includes passing a humid gas stream through a water-sorbing sorbent comprising a microporous coordination polymer, wherein the sorbent sorbs water from the passing humid gas stream to produce a water-sorbed sorbent and a dehumidified gas stream. This method also includes heating the water-sorbed sorbent to a temperature in a range of about 70° C. to about 300° C., or about 100° C. to about 300° C., or about 100° C. to about 250° C., or about 100° C. to about 200° C. to desorb the water and to regenerate the water-sorbing sorbent. Other suitable temperatures include, for example, about 70, 80, 90, 100, 110, 120, 130, 140, 150, 160, 170, 180, 190, 200, 210, 220, 230, 240, 250, 260, 270, 280, 290, or 300° C. Optionally a stream of drying gas can be passed through the sorbent during heating.

### Dehumidification

As used herein, the term “humidity” refers to relative humidity. The humid gas to be dehumidified can be of any relative humidity. The relative humidity of the humid gas prior to passing through the water-sorbing sorbent can be less than 1%, or in a range of about 1% to about 100%, or about 1% to about 30%, or about 1% to about 20%, or about 30% to about 100%, or about 30% to about 70%, or about 50% to about 100% or about 70% to about 100%, or about 70% to about 90%, or about 75%.

The humid gas to be dehumidified and the water-sorbing sorbent can be at any temperature suitable for the sorption of water from the humid gas stream. For example, the humid gas can be at a temperature in a range of about 20° C. to about 60° C., or about 20° C. to about 50° C., or about 20° C. to about 40° C., or about 20° C. to about 30° C., or about 25° C.

The pressure of the humid gas as it is passed through the water-sorbing sorbent is generally greater than 1 atm. For example, the pressure of the humid gas as it is passed through the water-sorbing sorbent can be in a range of about 1 atm to about 20 atm, or about 4 atm to about 15 atm, or about 6 atm. As used herein, “passing” of a humid gas stream through the sorbent refers to generating a gas stream flow in the vicinity of the water-sorbing sorbent such that at least a portion of the flowing gas penetrates through pores of the water-sorbing sorbent.

The humid gas stream can be passed through the water-sorbing sorbent at any rate suitable for dehumidification. For example, the humid gas can be passed through the water-sorbing sorbent at an hourly space velocity in a range of about 50 h⁻¹ to about 50,000 h⁻¹, about 50 h⁻¹ to about 40,000 h⁻¹, about 50 h⁻¹ to about 30,000 h⁻¹, about 50 h⁻¹ to about 20,000 h⁻¹, about 50 h⁻¹ to about 10,000 h⁻¹, about 50 h⁻¹ to about 5,000 h⁻¹, about 50 h⁻¹ to about 1,000 h⁻¹, about 50 h⁻¹ to about 500 h⁻¹, about 50 h⁻¹ to about 400 h⁻¹, about 50 h⁻¹ to about 300 h⁻¹, about 50 h⁻¹ to about 200 h⁻¹, about 50 h⁻¹ to about 100 h⁻¹, about 100 h⁻¹ to about 50,000 h⁻¹, about 500 h⁻¹ to about 50,000 h⁻¹ about 1,000 h⁻¹ to about 50,000 h⁻¹, about 5,000 h⁻¹ to about 50,000 h⁻¹, about 10,000 h⁻¹ to about 50,000 h⁻¹, about 20,000 h⁻¹ to about 50,000 h⁻¹, about 30,000 h⁻¹ to about 50,000 h⁻¹, or about 40,000 h⁻¹ to about 50,000 h⁻¹

The humid gas stream can be dehumidified to any desired level. For example, the water-sorbing sorbent can remove about 1% to about 100%, or about 5% to about 95% of the water in the humid gas stream. Other suitable amounts of water removed from the humid gas stream include, for example, 5, 10, 15, 20, 25, 30, 35, 40, 45, 50, 55, 60, 65, 70, 75, 80, 85, 90, 95, 96, 97, 98, 99, or 100%

The duration of the dehumidification process will vary depending on the relative humidity of the humid gas stream and the extent of drying required for a given flow rate of the humid gas stream. For example, a longer contact time would be required for a stream of gas that has a high humidity and a shorter contact time would be required for a stream of gas that has a low humidity. Additionally a deep drying may require a longer contact time than a superficial drying. As used herein, “deep drying” refers to substantially complete dehumidification of a gas-stream such that the resulting dehumidified gas stream has substantially no humidity (i.e., about 0% relative humidity). The humid gas stream can be passed through the water sorbing sorbent for any suitable time, for example a time in a range of about 1 min to about 1 day, or about 1 min to about 1 hour, or about 1 hour to about 12 hours. Other suitable dehumidification times include, for example, 1, 2, 3, 4, 5, 6, 7, 8, 9, 10, 11, 12, 13, 14, 15, 16, 17, 18, 19, 20, 21, 22, 23, or 24 hours.

The selection of a MCP for the water-sorbing sorbent will depend upon the relative humidity of the gas to be dehumidified and the extent of dehumidification required. The water-sorbing sorbent can be comprised of a MCP or mixture of MCPs with the appropriate water capacity and water affinity for a given application. For example, a MCP may be designed to be high capacity, high affinity; high capacity, low affinity; or low capacity, high affinity. The affinity of the MCP for water will also affect the contact time required for gas-dehumidification for a given flow rate of the humid gas stream. For example, a high affinity MCP will require a shorter contact time than a low affinity MCP for drying a gas stream having the same relative humidity.

Prior to passing the humid gas stream through a water-sorbing sorbent, the water-sorbing sorbent can be activated to remove any molecules (solvent, water, gases, impurities) that may have sorbed to the sorbent prior to use. The water-sorbing sorbent can be activated by passing a drying gas through the sorbent. The drying gas can be, for example, air, nitrogen, or argon. In various embodiments, the drying gas can be heated to a temperature of about 70° C. to about 250° C.

As noted above, the methods disclosed herein can be used to dehumidify a variety of gases including, for example, air, oxygen, argon, hydrogen, carbon monoxide, carbon dioxide, light hydrocarbons, and nitrogen.

### Regeneration

As used herein, the term “regeneration” refers to any process in which the sorbed water in a water-sorbed sorbent is desorbed, thereby resulting in a water-sorbing sorbent capable of sorbing water in a further dehumidification cycle. In one embodiment, the water-sorbing sorbent is regenerated by passing a drying gas through the water-sorbed sorbent. As used herein, the term “drying gas” refers to a gas that is used to desorb water from a water-sorbed sorbent. “Drying gas” as used herein does not necessarily refer to a dry gas. Drying gases suitable for use to desorb water from the water-sorbed sorbent are well known in the art. Suitable drying gases include, but are not limited to, air, nitrogen, and argon. The relative humidity of the drying gas may be any relative humidity and is generally of lower relative humidity than the humid gas stream. If a drying gas having substantially the same relative humidity as the humid gas is used, the drying gas can be heated to a temperature higher than that of the humid gas stream for regeneration of the sorbent, thus reducing the relative humidity. The relative humidity of the drying gas can be less than 1%, or in a range of about 1% to about 100%, or 1% to about 70%, or 1% to about 50%, or 1% to about 30%, or 30% to about 70%, or about 50%.

The drying gas can be at any suitable pressure for desorbing water from the water-sorbed sorbent at a given temperature. For example, the drying gas can be at a pressure of less than about 3 atm, or less than about 2 atm, or in a range of about 1 atm to about 2 atm. In one embodiment, the drying gas is the dehumidified gas that has been allowed to expand at a pressure lower than that of the humid gas stream and is then recycled through the sorbent.

The drying gas can be passed through the water-sorbed sorbent at any rate suitable for desorption. For example, the drying gas can be passed through the water-sorbed sorbent at an hourly space velocity in a range of about 50 h⁻¹ to about 50,000 h⁻¹, about 50 h⁻¹ to about 40,000 h⁻¹, about 50 h⁻¹ to about 30,000 h⁻¹, about 50 h⁻¹ to about 20,000 h⁻¹, about 50 h⁻¹ to about 10,000 h⁻¹, about 50 h⁻¹ to about 5,000 h⁻¹, about 50 h⁻¹ to about 1,000 h⁻¹, about 50 h⁻¹ to about 500 h⁻¹, about 50 h⁻¹ to about 400 h⁻¹, about 50 h⁻¹ to about 300 h⁻¹, about 50 h⁻¹ to about 200 h⁻¹, about 50 h⁻¹ to about 100 h⁻¹, about 100 h⁻¹ to about 50,000 h⁻¹, about 500 h⁻¹ to about 50,000 h⁻¹, about 1,000 h⁻¹ to about 50,000 h⁻¹, about 5,000 h⁻¹ to about 50,000 h⁻¹, about 10,000 h⁻¹ to about 50,000 h⁻¹, about 20,000 h⁻¹ to about 50,000 h⁻¹, about 30,000 h⁻¹ to about 50,000 h⁻¹, or about 40,000 h⁻¹ to about 50,000 h⁻¹.

The drying gas can be at any temperature suitable for desorbing water from the water-sorbed sorbent. For example, the drying gas can be at a temperature in a range of about 25° C. to about 300° C., or about 40° C. to about 250° C., or about 70° C. to about 150° C., or about 70° C. to about 100° C., or about 100° C. to about 200° C. Other suitable temperatures, include, for example, about 25, 30, 40, 50, 60, 70, 80, 90, 100, 110, 120, 130, 140, 150, 160, 170, 180, 190, 200, 210, 220, 230, 240, and 250° C. Advantageously, the water-sorbing sorbent of the disclosure can be designed such that the drying gas need not be heated. In one embodiment, the water-sorbed sorbent and the drying gas are not heated during the passing of the drying gas through the water-sorbed sorbent. In another embodiment, the temperature of the water-sorbed sorbent and the drying gas is elevated relative to the temperature of the water-sorbing sorbent and the humid gas stream.

In various embodiments, the water-sorbed sorbent can be regenerated for use in further dehumidification cycles by heating the water-sorbed sorbent to a temperature in a range of about 25° C. to about 300° C., or about 70° C. to about 300° C., or about 100° C. to about 300° C., or about 100° C. to about 250° C., or about 100° C. to about 200° C. Other suitable temperatures include, for example, about 30, 40, 50, 60, 70, 80, 90, 100, 110, 120, 130, 140, 150, 160, 170, 180, 190, 200, 210, 220, 230, 240, 250, 260, 270, 280, 290, and 300° C. In one embodiment, a drying gas is also passed through the sorbent during heating. In another embodiment, a drying gas is not passed through the sorbent during heating.

The amount of water removed from a water-sorbed sorbent can be any amount suitable for a given application. For example, the regeneration process can remove about 20% to about 100%, or about 30% to about 95%, or about 40% to about 90% of the sorbed water from the water-sorbed sorbent. Other suitable amounts of sorbed water removed during regeneration can include, for example, about 20, 25, 30, 35, 40, 45, 50, 55, 60, 65, 70, 75, 80, 85, 90, 95, 98, 99, and 100%. The water-sorbing capacity of the regenerated water-sorbing sorbent can be in a range of about 10% to about 95%, or about 25% to about 90%, or about 50% to about 90%, or about 75% to about 90% of the original capacity of the water-sorbing sorbent. Other suitable capacities include, for example, about 10, 15, 20, 25, 30, 35, 40, 45, 50, 55, 60, 65, 70, 75, 80, 85, 90, 95, 98, 99, and 100%. Advantageously, the sorbents can be regenerated such that there is substantially no loss in capacity and substantially no loss of sorption efficiency.

A water-sorbed sorbent can be regenerated to a water-sorbing sorbent with at least about 90% of the sorption capacity of the original water-sorbing sorbent. Advantageously, it has been found that sorbents according to the disclosure can be designed such that the regeneration to at least 90% capacity of the water-sorbing sorbent can be completed in about 3 hours or less, or in a range of about 1 min to about 1 hour. Other suitable dehumidification times include, for example, a time in a range of about 1 min to about 1 day, or about 1 hour to about 12 hours, or 1, 2, 3, 4, 5, 6, 7, 8, 9, 10, 11, 12, 13, 14, 15, 16, 17, 18, 19, 20, 21, 22, 23, or 24 hours.

A regenerated water-sorbing sorbent can be used to dehumidify additional humid gas streams. Advantageously, the sorbents of the disclosure can be repeatedly sorbed and desorbed of water. After each regeneration cycle, the sorbing capacity of the water-sorbing sorbent is at least about 99%, 98%, 95%, 90%, 80%, 70%, or 60% of the original sorption capacity.

### Water-Sorbing Sorbents

The water sorbing sorbents of the methods of the disclosure include a microporous coordination polymer (MCP) and/or derivatives thereof. The water-sorbing sorbent include a single MCP or a mixture of MCPs. The water-sorbing sorbent can include other sorbents, including, but not limited to, zeolites, alumina, and carbons, support materials, binders, and/or thermal management materials in addition to the one or more MCPs.

Microporous coordination polymers (MCPs) and methods of making MCPs are well known in the art. Generally, MCPs are polymers and most typically three-dimensional coordination complexes that include a plurality of inorganic metal clusters linked together by a plurality of linking ligand compounds. The inorganic metal clusters can include a plurality metals connected by a plurality of bridging moieties. The metals of the clusters can be cationic and are generally hexacoordinate, pentacoordinate, tetracoordinate, or a mixture thereof. In one embodiment, each metal cluster is the same. In an alternative embodiment, the make-up of the metal cluster can differ throughout the MCP. For example, a MCP may be comprised of 2 or 3 different metal clusters. The inorganic metals and linking ligands may be chosen such that the overall MCP framework has a net charge. A description of suitable MCPs for use as the water-sorbing sorbents for the gas dehumidification methods of the disclosure can be found in U.S. Pat. Nos. 7,202,385; 7,196,210; 6,930,193; 6,929,679; and 5,648,508 and in U.S. Patent Application Publication Nos. 2007/0068389; 2006/0252641; 2006/0185388; 2006/0154807; 2005/0192175; and 2005/0154222; the respective disclosures of which are hereby incorporated by reference in their entireties.

The sorption capacity of the MCP can be, for example, about 30 wt. % to about 200 wt. % based on the total weight of the MCP. For example, the capacity can be about 30 wt. % to about 100 wt. %, about 30 wt. % to about 50 wt. %, about 50 wt. % to about 200 wt. %, about 100 wt. % to about 200 wt. %, and about 150 wt. % to about 200 wt. % based on the weight of the dry MCP, as measured at about 75% relative humidity, 1 atm, and 25° C. Other suitable capacities include, for example, about 30, 35, 40, 45, 50, 55, 60, 65, 70, 75, 80, 85, 90, 95, 100, 110, 120, 130, 140, 150, 160, 170, 180, 190, and 200 wt. %. For example, a MCP for use in a deep drying application can have a sorption capacity of less than about 50 wt %. Suitable sorption capacities for deep drying applications can include, for example, about 50, 45, 40, 35, 30, 25, 20, 15, or 10 wt %. A MCP used in a deep drying application also generally has a high affinity for water.

Advantageously, with various MCP containing water-sorbents, the level of MCP hydration can be determined by visual inspection when the sorbents contain water. In some embodiments, the color of the MCP bed changes gradually from the humid gas inlet to the drying gas outlet while the equilibrium zone and mass transfer zone move through the bed during dynamic adsorption. For example, a water sorbing sorbent comprising the MCP HKUST-1 is purple and as water is sorbed the MCP becomes light blue. As another example, a water sorbing sorbent comprising the MCP Co/DOBDC is black and a water-sorbed sorbent comprising the MCP Co/DOBDC is red. As yet another example, a water-sorbing sorbent comprising the MCP MIL-101 is greenish grey and becomes green upon the sorption of water from the humid gas.

Furthermore, in some embodiments, the level of MCP hydration can be observed by analyzing the refractive index of the MCP, which for various MCPs changes based on the level of hydration. Thus, it is also possible to observe the level of hydration for colorless water-sorbing sorbents that remain colorless upon sorption of water.

In one embodiment, the water-sorbing sorbent includes one or more MCPs described by Formula I:

[R(L)ₙ]ₘ[Mₓ(μ-E)_{y}], FORMULA I:

wherein M is one or more metals; R is an organic spacer; L is a linking ligand that attaches the metal to the organic group; μ-E is a bridging moiety between two metals; y is in a range of 0 to 4; n is less than or equal to 8; m equals the total charge of [Mₓ(μ-E)_{y}] divided by n; and x is the number of metals in [Mₓ(μ-E)_{y}]. For example, y can be 0, 1, 2, 3, or 4 and n can be 0, 1, 2, 3, 4, 5, 6, 7, or 8. In various embodiments, m can be in a range of 0 to 10 (0≦m≦10). For example, in one embodiment, m is in a range of 4 to 6 (4≦m≦6). In various embodiments, x is in a range of 1 to 10 (1<x≦10).

In an MCP represented by Formula I, the metal (M) can include one or more transition metals, rare earth metal, or other element selected from the group consisting of elements from groups 1 to 16 of the Periodic Table, and combinations thereof. Specific examples of suitable metal ions used include, but are not limited to, one or more ions selected from the group consisting Li⁺, Na⁺, K⁺, Rb⁺, Be²⁺, Mg²⁺, Ca²⁺, Sr²⁺, Ba²⁺, Sc³⁺, Y³⁺, Ti³⁺, Zr⁴⁺, Hf⁴⁺, V⁵⁺, V⁴⁺, V³⁺, V²⁺, Nb⁵⁺, Nb³⁺, Ta⁵⁺, Ta³⁺, Cr⁶⁺, Mo⁶⁺, Mo³⁺, W⁶⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh³⁺, Rh²⁺, Rh⁺, Ir³⁺, Ir⁺, Ni³⁺, Ni²⁺, Pd⁴⁺, Pd²⁺, Pt⁴⁺, Pt²⁺, Cu²⁺, Cu⁺, Ag⁺, Au³⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, and combinations thereof.

The bridging moiety, can be an element from groups 13 to 17 of the Periodic Table or a bridging ligand. The MCP can include bridging ligands that are each the same. Alternatively, different bridging ligands can be included in the MCP. For example, the bridging ligands can include y different bridging moieties. Suitable bridging moieties include, but are not limited to, O²⁻, OH⁻, N³⁻, NH²⁻, NH₂⁻, S²⁻, F⁻, Cl⁻, Br⁻, and I⁻.

The organic spacer (R) can be cyclic or acyclic organic compounds. Each organic spacer included in the MCP can be the same. Alternatively, the MCP can include a number of different organic spacers. For example, a MCP can include m different types of R in a given MCP.

The linking ligand (L) is a chemical species (including neutral molecules and ions) that coordinate two or more metal atoms or metal clusters resulting in an increase in their separation, and the definition of void regions or channels in the framework that is produced. The linking ligand can be, but is not limited to a carboxylate, thiocarboxylate, dithiocarboxylate, imidate, phosphonate, phosphoimidate, guanidate, β-diketonate, or β-dithionate, for example, 4,4′-bipyridine or benzene-1,4-dicarboxylate. Each linking ligand included in a MCP can be the same. Alternatively, a number of different linking ligands can be included in the MCP.

Suitable MCPs for use herein include, but are not limited to, HKUST-1, MOF-74, MOF-5, IRMOF-3, IRMOF-9, IRMOF-20, MOF-177, MOF-505, UMCM-150, UMCM-152, UMCM-153, MIL-47, MIL-53, MIL-100, MIL-101, Co/DOBDC, Ni/DOBDC, Fe/DOBDC, UiO-66, UiO-67, UiO-68, ISE-1, [Zn(l-L)(Cl)](H₂O)₂ [L=3-methyl-2-(pyridine-4-ylmethylamino)-butanoic acid], [Zn(l-L)(Br)](H₂O)₂, [Zn(d-L)(Cl)](H₂O)₂, [Zn(d-L)(Br)](H₂O)₂, Cu(4,4′-bipyridine)₂(BF₄)₂, MOF-14, and derivatives thereof. Suitable derivatives of the foregoing MCPs include those with metal substitutions.

It has advantageously been recognized that MCPs can be particularly tailored for specific humidity conditions by tailoring the linking ligand and/or metal(s) of a MCP for the specific application. Factors affecting the water-sorption capacity and the water affinity of a MCP include, for example: the presence or absence of coordinatively unsaturated metals; the pore size and shape of the MCP; the nature of the organic linker of the MCP; the charge of the MCP pore wall; and the introduction of any functional groups, such as hydrogen bond donor or acceptor groups, to the MCP. Thus, for certain applications, the MCPs of the water-sorbing sorbents can be particularly tailored for the dehumidification of a humid gas with a high relative humidity, e.g., a relative humidity greater than 50%. In other applications, the MCPs of the water-sorbing sorbents can be particularly tailored for dehumidification of humid gas with a low relative humidity, for example, less than 30% relative humidity. Embodiments of the method can include tailoring the water-sorbing sorbent for a desired application before passing the humid gas stream through the water-sorbing sorbent. Tailoring the water-sorbing sorbent for a desired application can include, for example, selection of a MCP or mixture of MCPs having desired sorbing properties and/or modification of a MCP to modify the sorbing properties to be within a desired range.

In various embodiments, a metal of the MCP of the water-sorbing sorbent may be coordinatively unsaturated. As used herein, the term “coordinatively unsaturated metal” refers to a transition metal that possesses fewer ligands than exist in the coordinatively saturated metal. For example, the dinuclear copper paddlewheel in HKUST-1, lacking apical ligands, has two coordinatively unsaturated metals. The number of open coordination sites on the metal of a MCP may be any suitable number such that the MCP maintains its structure. For example, in one embodiment, the metal of a MCP has one open coordination site. In another embodiment, the metal of a MCP has two open coordination sites. Each metal of a given MCP need not be equally unsaturated. For example, one or more of the metals of a MCP can be saturated, while one or more metals of the MCP can have one or more open coordination sites. In one embodiment, each metal of a MCP is saturated. In another embodiment, each metal of a MCP has one or more open coordination sites. A MCP with coordinatively unsaturated metal centers may be able to better coordinate the water through the oxygen atom, allowing for high uptake of water. Thus, a MCP with at least one coordinatively unsaturated metal may be able to better coordinate the water from the humid gas stream, thereby increasing the affinity of the sorbent for water as compared to a coordinatively saturated metal. Such MCPs can be particularly useful for sorbing a humid gas stream having a high relative humidity.

The water-sorption properties of a MCP can also be tailored by modifying the nature of the organic linker of the MCP. For example, a hydrophilic organic linker may be employed to achieve increased water sorption capacity because of better interaction of the linker with the electron-rich water. Alternatively a more hydrophobic organic linker may be employed to achieve efficient water-desorption because the water molecules will not strongly interact with the linker and therefore will be easier to remove during regeneration. The methods of the disclosure can advantageously utilize this tailorability to provide an appropriate balance between water sorption capacity and affinity depending on the conditions of the humid gas stream to be dehumidified.

The selection of the organic linker can also be used to control the pore size and shape of the MCP. As the length of the organic molecule used as a linker is increased, the pore size also increases and as the length of the organic molecule used as a linker is decreased, the pore size also decreases. The water-sorbing sorbents can include a MCP having a pore size, for example of about 0.5 nm to about 5 nm, or about 1 nm to about 4 nm, about 0.5 nm to about 3 nm, about 0.5 nm to about 1.5 nm, or about 1 nm. Other suitable pore sizes can include, for example, 0.5, 0.6, 0.7, 0.8, 0.9, 1, 1.2, 1.4, 1.5, 1.6, 1.8, 1.9, 2, 2.2, 2.4, 2.6, 2.8, 3, 3.2, 3.4, 3.6, 3.8, 4, 4.2, 4.4, 4.6, 4.8, and 5 nm. The pore size of the MCP is another feature that can be adjusted to control the water-affinity of the sorbent. For example, a smaller pore size will lead to an increase in the interaction between the water molecule and the pore wall, thus resulting in a stronger bond between the water molecule and the sorbent. This can result in an increased affinity of the sorbent for water, thereby allowing the sorbent to have high affinity for dehumidifying lower relative humidity gas streams. However, if the pore size is too small, the water molecule will not be able to enter the pore to interact with the pore wall, leading to a decreased capacity of the sorbent. Thus, the pore size will typically be larger than the kinetic diameter of water. Similarly, as the pore size is increased, the capacity of the sorbent will increase as more water molecules may fit into the pore. The affinity, however, may decrease, as the interaction of each water molecule with the pore wall will decrease. The methods of the disclosure can advantageously utilize this tailorability to provide an appropriate balance between water sorption affinity and sorption capacity depending on the conditions of the humid gas stream to be dehumidified.

A MCP according to the disclosure may also be modified by one or more components selected from the group consisting of amines, alcohols, ethers, ketones, esters, carboxylic acids, amides, phosphonates, phosphates, sulfoxides, sulfones, sulfonamide, thiols, nitriles, and combinations thereof. For example, the pore walls can be modified with hydrogen bond donor groups and/or hydrogen bond acceptor groups. Additionally, a MCP can be modified such that the pore wall of the MCP is charged. A MCP modified with hydrogen bond donor groups may, for example, lead to an increased affinity of the sorbent for the oxygen of the water molecules, thereby leading to an increased affinity for water. Similarly, the modification of a MCP with hydrogen bond acceptor groups may lead to an increased affinity for the hydrogens of the water molecules, thereby also leading to an increased affinity for water. Thus, it has been advantageously determined that such modified MCP sorbents can have high affinity suitable for dehumidifying lower relative humidity gas streams, such as, for example, in deep drying applications. The extent and type of modification of the pore walls of the sorbent can be varied across a MCP and can be particularly tailored to provide a MCP having desired sorption characteristics for a particular dehumidification application.

### EXAMPLES

### Example 1

Four sorbents based on the MCPs Co/DOBDC, HKUST-1, MIL-100, and MIL-101, were activated under argon gas flow. The water capacities of the sorbents were determined under the following conditions: a pressure of 14.7 psi, NIST STP flow rate of 30 mL/min, 75% relative humidity, and at a temperature of 25° C. The water capacities were compared to the water capacity of commercial activated alumina under the same conditions.

The water capacities of Co/DOBDC, HKUST-1, MIL-100, and MIL-101 were determined to be 66 wt. %, 100 wt. %, 119 wt. %, and 159 wt. %, respectively, compared to 26 wt. % for activated alumina under the same conditions.

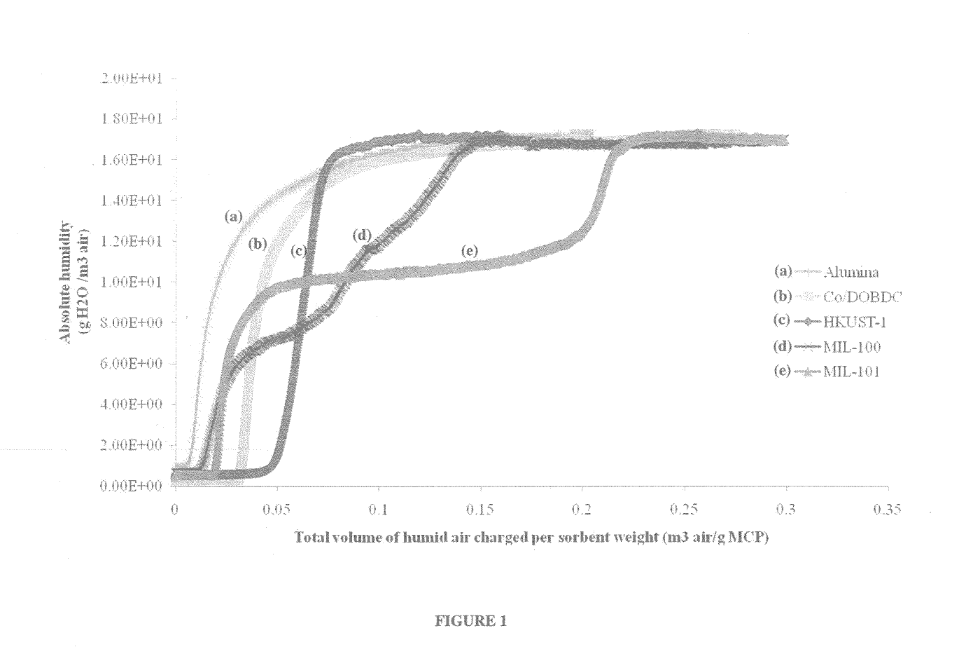

FIG. 1 shows the water/air breakthrough curves for packed columns, 20 mg each, of for (a) commercially available, conventional activated alumina, (b) Co/DOBDC, (c) HKUST-1, (d) MIL-100, and (e) MIL-101 under 14.7 psi (1 atm), NIST STP flow rate of 30 mL/min, 75% relative humidity and 25° C.

### Example 2

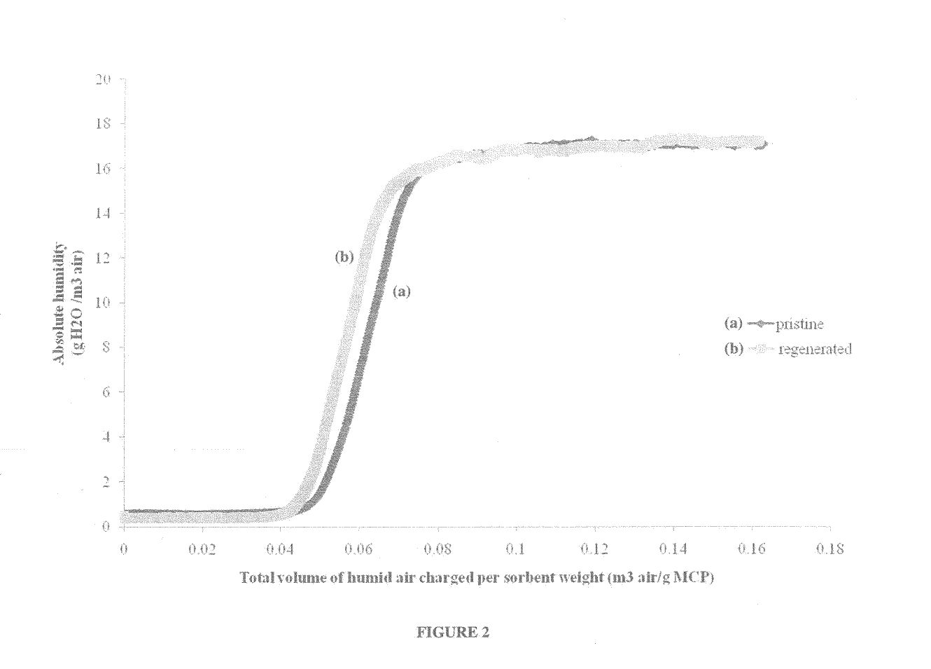

The HKUST-1 sorbent of Example 1 was regenerated by exposing the sorbent to Argon, as a drying gas, at 170° C. FIG. 2 shows water/air breakthrough curves of (a) initially activated and (b) regenerated HKUST-1. FIG. 2 shows that the capacity of the regenerated sorbent is almost completely restored after regeneration. As used in the examples “initially activated” refers to a first dehumidification performed by the sorbent.

### Example 3

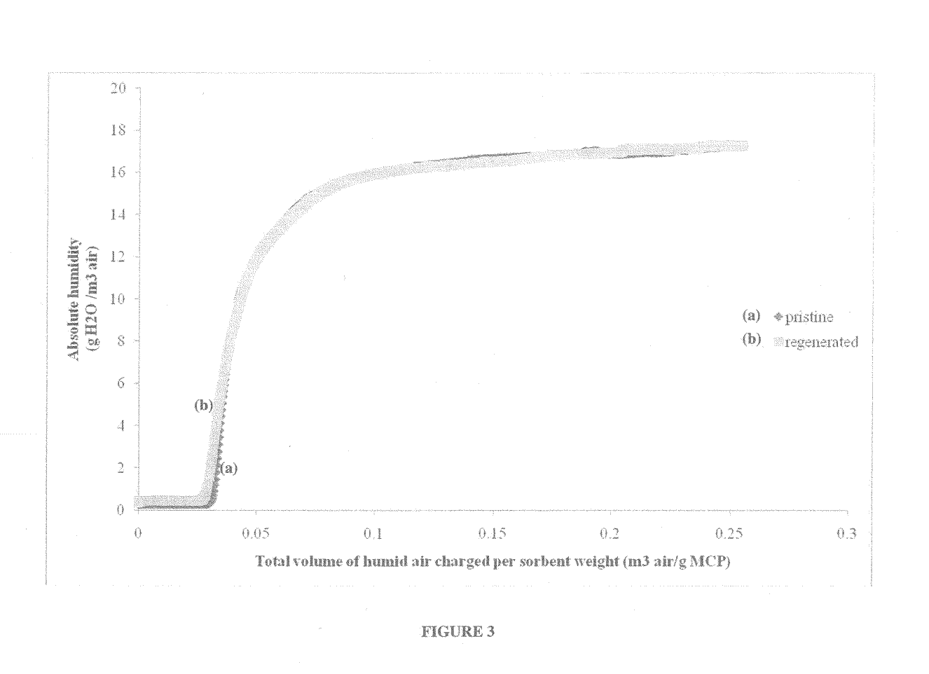

The Co/DOBDC sorbent of Example 1 was regenerated by exposing the sorbent to Argon, as a drying gas, at 250° C. FIG. 3 shows the water/air breakthrough curves of (a) initially activated and (b) regenerated Co/DOBDC. FIG. 3 shows that the capacity of the regenerated sorbent is completely restored after regeneration.

### Example 4

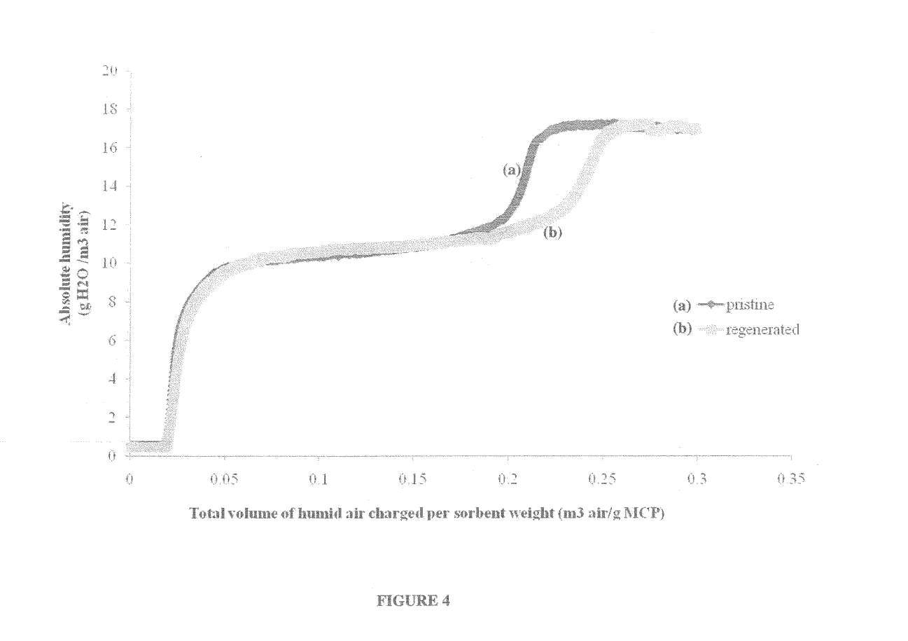

The MIL-101 sorbent of Example 1 was regenerated by exposing the sorbent to Argon, as a drying gas, at 150° C. FIG. 4 shows water/air breakthrough curves of (a) initially activated and (b) regenerated MIL-101. FIG. 4 shows that the capacity of the regenerated sorbent is higher after regeneration than the initially activated sorbent.

We claim:

1. A gas-dehumidification method comprising:
passing a humid gas stream through a water-sorbing sorbent comprising a microporous coordination polymer or derivative thereof, wherein the sorbent sorbs water from the passing humid gas stream to produce a water-sorbed sorbent and a dehumidified gas stream; and,
passing a drying gas through the water-sorbed sorbent under conditions sufficient to desorb the water and to regenerate the water-sorbing sorbent.

2. A gas-dehumidification method comprising:
passing a humid gas stream through a water-sorbing sorbent comprising a microporous coordination polymer or derivative thereof, wherein the sorbent sorbs water from the passing humid gas stream to produce a water-sorbed sorbent and a dehumidified gas stream; and,
heating the water-sorbed sorbent to a temperature greater than 100° C., up to about 250° C. to desorb the water and to regenerate the water-sorbing sorbent.

3. The method of claim 2, further comprising passing a drying gas through the water-sorbed sorbent during heating.

4. The method of claim 2, wherein 80% of the water contained in the water-sorbed sorbent is desorbed in less than about 3 hrs.

5. The method of claim 3, wherein the drying gas is air.

6. The method of claim 3, wherein the drying gas is at a pressure lower than that of the humid gas stream.

7. The method of claim 6, wherein the pressure of the drying gas is in a range of about 1 to about 2 atm.

8. The method of claim 6, wherein the humid gas stream is at a pressure in a range of about 2 to about 20 atm.

9. The method of claim 2, wherein the temperature of the water-sorbing sorbent is in a range of about 20° C. to about 60° C.

10. The method of claim 2, wherein the microporous coordination polymer has the following formula:
[R(L)ₙ]ₘ[Mₓ(μ-E)_{y}]
wherein:
M comprises a transition metal, rare earth metal, or other element selected from the group consisting of elements from groups 1-16 of the Periodic Table, and combinations thereof;
R comprises an organic spacer selected from a general group consisting of cyclic or acyclic organic compounds;
L is a linking moiety that attaches the metal to the organic spacer and is selected from the group consisting of carboxylate, thiocarboxylate, dithiocarboxylate, imidate, phosphonate, phosphoimidate, guanidate, P-diketonate, or P-dithionate;
μ-E represents a bridging element selected from the group consisting of elements from groups 13-17 of the Periodic Table;
y is a number from 0 to 4;
n is a number less than or equal to 8;
m is the total charge of [Mₓ(μ-E)_{y}] divided by n; and x is the number of metals in [Mₓ(μ-E)_{y}].

11. The method of claim 10, wherein y is 0.

12. The method of claim 2, wherein the microporous coordination polymer has coordinatively unsaturated metals.

13. The method of claim 2, wherein the microporous coordination polymer has a pore size in a range of about 0.5 nm to about 5 nm.

14. The method of claim 2, wherein the microporous coordination polymer has been modified with a component selected from the group consisting of amines, alcohols, ethers, ketones, esters, carboxylic acids, amides, phosphonates, phosphates, sulfoxides, sulfones, sulfonamide, thiols, nitriles, and combinations thereof.

15. The method claim 2, wherein the humid gas stream has a relative humidity in a range of about 1% to about 29% prior to passing through the water-sorbing sorbent.

16. The method of claim 15, wherein the relative humidity is about 1% to about 20%.

17. The method of claim 2, wherein the microporous coordination polymer has a sorption capacity in a range of about 30 wt. % to about 200 wt. % at about 75% relative humidity, 1 atm, and 25° C.

18. The method of claim 2, wherein the water-sorbing sorbent, following regeneration, has an adsorption capacity of at least about 90% of its original capacity.

19. The method of claim 2, wherein the humid gas stream comprises one or more of air, oxygen, argon, hydrogen, carbon monoxide, carbon dioxide, light hydrocarbons, and nitrogen.

20. The method of claim 19, wherein the humid gas stream is air.
